(19) United States
(12) Patent Application Publication
(10) Pub. No.: US 2006/0016759 A1
(43) Pub. Date: Jan. 26, 2006

(54) Process for the oily sludge of food byproducts

(76) Inventor: John H. Lee, Olathe, KS (US)

Correspondence Address: RIGEL TECHNOLOGY CORPORATION, 11800 WEST 63 STREET, SUITE 26, SHAWNEE, KS, 66203, US

(21) Appl. No.: 10/895,689

(22) Filed: Jul. 21, 2004

(51) Int. Cl. C02F 1/24; A23K 1/04

(52) U.S. Cl. 210/703; 426/658

(57) ABSTRACT

A novel processing method of producing non-oily dissolved air flotation (DAF) sludge or vegetable soap stock sludge product is provided. The oily sludge from a dissolved air flotation unit in a food waste water treatment plant or from vegetable soap stock in a vegetable oil processing plant is converted into non-oily property by alkali and water absorbent to form fatty acid salts. The non-oily product is dried by a normal dryer. The issues of pollution, waste water, and processing cost for DAF sludge are resolved or reduced by this practical and economical processing method. Also the product properties are improved. The method could save millions of dollars for food and feed industries.

### FIELD OF THE INVENTION

The present invention relates to the processing method of treating the food by-products, and more particularly to the processing method of converting the oily sludge from dissolved air flotation units or the oily sludge (it is often called vegetable soap stock) from vegetable oil process into the non-oily and value-added products for feed applications.

### BACKGROUND OF THE INVENTION

Food processing plants produce food products. Also most food processing plants use large volume water to wash the food products and produce waste water with high BOD (biological oxygen demand), COD (chemical oxygen demand), FOG (fats, oils and grease), SS (suspended solids) and TKN (total Kjeldahl nitrogen). Waste water is a big issue in the food industry, which effects life and environment. Dissolved air flotation (DAF) units have been used in food processing plants and waste water treatment plants for many years. The purpose of DAF units is to reduce BOD, COD, SS, FOG and TKN in the waste water passing to sewage treatment or to discharge. But it creates a problem how to deal with the oily and pasty sludge (it is also often called DAF skimming), which has nutrients of fat, protein, carbohydrate, and others. The amount of fat and protein of the oily sludge from a typical animal processing plant is about 85-90% on a solids basis, which has nutritional value. For corn processing plans, the major contents of DAF sludge are fat and carbohydrate. For soybean processing plans, the major contents of DAF sludge are fat, protein, and carbohydrate. DAF sludge can not be dried by a normal drying process because DAF sludge is very oily. Fat becomes liquid oil diring a drying process with a heater. Also DAF sludge often has a pasty property, which often sticks together and to the wall of equipment during a drying process. There are three common methods to deal with DAF sludge currently. Land spread is often used because it is cheap and easy method. But it causes pollution problems to the land, water and air. A related fee is usually charged. The potential nutritional value of DAF sludge is lost through microbiological degradation, which produces more microorganisms. For an average animal processing plant, there is about 15,000 tons (or 30,000,000 pounds) of oily and pasty DAF sludge produced per year. It is estimated for 500 plants that there is about 7,500,000 tons (or 15,000,000,000 pounds) of oily and pasty DAF sludge produced per year, which is a huge number. We need to resolve the issue. Another method is to blend DAF sludge with other by-products such as poultry or meat/bone byproducts. Typical DAF sludge from animal processing plants has moisture level about 75-85%. The moisture level is about 3 to 5.7 times of the solids in DAF sludge. More energy is needed to heat DAF sludge to remove the fat and moisture for a dry product. Also DAF sludge addition effects the processes and quality for other byproducts. The third method is to cook DAF sludge to about 95 degree C. with hot steam and to centrifuge the cooked DAF sludge with a 2-phase or 3-phase centrifuge into fat, waste water, and solid phases. This cooking process separates DAF sludge and produces waste water from the water of DAF sludge and steam. The waste water is very dirty because of two major reasons. One reason is the high temperature, which significantly increases the solubility for organic matter. Another reason is the mechanical share from the centrifuge, which breaks organic matter of DAF sludge. So the waste water has high BOD, COD, FOG, SS, and TKN than normal waste water. Waste water is an important issue causing a pollution problem for food and feed processing plants. The fat separated from DAF sludge has low value compared with normal fat ingredients. The sale price is only about ⅓. Typical DAF sludge from animal processing plants has about 15-25% solids with major fat and protein. We need an efficient and economical method to process DAF sludge. Vegetable soap stock such as soy, corn or canola oil soap stock is a byproduct produced during vegetable oil process, which contains free fatty acids. The byproduct is also oily sludge which normally has about 45% fat and 50% moisture. The oily sludge is not possible to be processed into a dry and non-oily product by a normal dry process. The sludge is often to be adjusted for pH, heated and vacuumed into a liquid oil form after removing the moisture. We have invented the processing methods to convert above two oily sludge byproducts into non-oily products by associating with some protein ingredients. We also need to treat the oily sludge byproduct without the protein ingredients to meet practical situations.

Over the years, various attempts have been made to use and to improve the oily sludge and oil ingredients. A number of patents have been issued for these attempts. U.S. Pat. No. 6,576,667 discloses a method for manufacturing fatty acid salts from high glyceride content oils with eicosapentaenoic acid and docosaheaenoic acid into a calcium salt product by adding 2 to 3 equivalents of calcium oxide relative to the oils and 2 to 5 equivalents of water relative to the calcium oxide so that the calcium oxide hydrates and neutralizes the fatty acids to form calcium salts. The reaction is completed in a 210-240 degree F. U.S. Pat. No. 6,368,657 discloses a method for converting oily and pasty DAF sludge into a fat-protein product in a non-oily and non-pasty form with liquid animal blood by a heat treatment by the author. The product has the bypass protein (95%) and fat (85%) for dairy animals. But the dark color and smell of the product are two concerns. U.S. patent application Ser. No. 10/411,855 discloses a method for improving the fat-protein encapsulated product into the product with yellowish color, mild smell and low micro counts by the author. Both methods require liquid animal blood to be processed with DAF sludge together. U.S. patent application Ser. No. 10/657,028 discloses a method for encapsulating some liquid fat ingredients such as vegetable soap stock into non-oily solid products by associating with the protein coagulation under heat or pH change by the author. U.S. Pat. No. 6,229,031 discloses a method for preparing fatty acid glycerides into a calcium salt product by adding calcium oxide and water and then heating to a high temperature such as 150 degree C. at which the fatty acid glycerides saponify to form fatty calcium salts. The calcium soap salt product has the bypass function for ruminant animals. U.S. Pat. No. 5,514,388 discloses a process to treat protein with a base to increase the pH to such as 11 at first. Then the fat is added into the alkali protein. The protein firm gel is formed when the pH is lowed to 3 to 5. There are high minerals in the final product because more base and acid are used. U.S. Pat. No. 5,496,572 discloses a process to form a ruminant feed stuff by a homogeneous mixture of animal or vegetable protein material, one or more fatty acids, and a calcium or magnesium compound by an extrusion process. U.S. Pat. No. 4,427,572 discloses a process to prepare a calcium soap product by saponifying an organic carboxylic acid with calcium hydroxide in a dipolar aprotic solvent such as acetone. Then the calcium soap product are separated from the reaction mixture and excess acetone is removed from the calcium soap product. U.S. Pat. No. 4,217,370 discloses a process to treat protein with a base to increase the pH to such as 11. Then the fat is added into the alkali protein. The protein and fat are mixed together before any pH change. The protein gel is formed when the pH is lowed to the isoelectric point. U.S. Pat. No. 4,216,234 discloses a process to render albumin medium with strongly alkaline such as 11.5 prior to the formation of the fat dispersion or emulsion, and thereafter the dispersion or emulsion is heated to form a gel product. U.S. Pat. No. 4,138,505 discloses a process to heat animal blood to a temperature in the range of from about 20 degree C. to 60 degree C., to adjust the pH of the heated aqueous medium to a level ranging from 9 to about 13 to form a blood solid gel, and thereafter recovering the fat-protein gel.

Protein ingredients such as animal blood protein and soy protein are often processed into protein products for higher value. DAF sludge is a “waste” byproduct without or with low value. Vegetable soap stock sludge has low value. We need to develop some practical and economical methods to process DAF sludge and vegetable soap stock sludge into non-oily solid products without combining with protein sources such as liquid animal blood or soy protein milk. The major challenge for DAF sludge is its oily and pasty properties because of high fat and moisture levels, which are not possible to be treated and processed with a dryer. It is very important to use food byproducts for economic and public health achievements. The issues such as land pollution, waste water, and processing cost for DAF sludge are needed to be resolved. Also the oily property of the byproducts is needed to be improved into the non-oily property for more applications and convenient handling.

### SUMMARY OF THE INVENTION

The present invention overcomes the problems of other patents and provides a novel process to convert oily DAF sludge or oily vegetable soap stock sludge into a non-oily product. The objective of the present invention is to provide the processing method, which is convenient and economical to use.

It has been found there are free fatty acids in DAF sludge or vegetable soap stock sludge. The free fatty acids in DAF sludge or vegetable soap stock sludge is normally Is more than 35% on a fat basis. Free fatty acids have both hydrophobic and hydrophilic properties. This is the foundation for the processing method in this invention. The oily property of the oily sludge byproducts is converted into non-oily property by forming fatty acid salts.

A screen, press, filter or their combination is used to reduce the moisture level of DAF sludge at first. The removed water is usually clear, which goes to normal waste water and into a DAF unit to be treated. Commercial screen, press or filter equipment is available. It has been found oily DAF sludge is converted into non-oily product with some agents such as calcium oxide or calcium hydroxide. The reason may be that the polar groups such as free fatty acids in DAF sludge fat are changed into calcium salts. When pH is increased with such as calcium oxide, sodium hydroxide, magnesium oxide, calcium hydroxide, magnesium hydroxide or their combination, the oily property is converted into non-oily property. Calcium oxide is most commonly used. Feed-grade calcium oxide often contains about 73% calcium oxide and 23% chemically combined water. The negative molecules of free fatty acids in the sludge binds with positive calcium ions to form calcium salts. The non-polar groups in DAF sludge fat bind each other with hydrophobic bond. The calcium salts are on the surface of the product, which changes oily DAF sludge into non-oily wet product in some particle form. Heat helps the process to form the non-oily particle product. The dry calcium oxide also absorbs moisture in DAF sludge into less pasty product. A water absorbent is used to further absorb the moisture in DAF sludge to form a non-oily and non-pasty wet product in a particle form. There are commercial water absorbents. Some of them can absorb up to 500 times its weight in water. The wet product in the particle form has much more surface area, which helps the moisture in DAF sludge to be evaporated much faster and easy in a drying process. It reduces the drying cost in a drying process. If the moisture level in the pressed DAF sludge is low enough, a water absorbent is not necessary to be used. Calcium oxide is used to convert the pasty and oily DAF sludge into a non-pasty and non-oily wet particle product. After the process, the product contains the calcium salts, fat, and the animal proteins. The product may have bypass and protection functions for dairy animals. Some feed-grade chemicals such as calcium peroxide and Termin-8 (Anitox Corporation, Buford, Ga.) are used to improve bacterial and odor issues for the related product. To form better particle product, some cross linking agents such as formaldehyde, polyacrylamide, polyester, Termin-8, or polyacrylonitrile may be used to form large particles. The wet particle product is easily dried with a normal dryer such as flash dryer or drum dryer. The product with non-oily and non-pasty properties may also be mixed with soybean meal, corn meal, poultry meal, or other feed ingredients together.

Vegetable soap stock is heated to such as to about 60 degree C. into an uniform liquid form. When an alkali of calcium hydroxide, calcium oxide, sodium hydroxide, magnesium oxide, magnesium hydroxide or their combination is added and mixed, the free fatty acids are tend to form into soap salts. Heat helps the process to form the non-oily product. Then the oily property of the sludge is converted into non-oily property. The non-polar groups in the vegetable soap stock sludge bind each other with hydrophobic bonds. The calcium salts are on the surface of the product, which changes the oily sludge into non-oily product. Calcium oxide and sodium hydroxide are often used to convert the oily sludge into a non-oily liquid product, which is further dried by pouring into a thin layer or spray drying. The spray creates much more surface area, which helps the moisture in the sludge to be evaporated much faster in the drying process. The most content of the product is the fat in a calcium salt form. The product may have bypass and protection functions for dairy animals. The oily sludge is often to be heated and vacuumed into a liquid oil form after removing the moisture. Vegetable soap stock oil is treated with an alkali, calcium salts are formed to change into non-oily product. When the temperature is high than 50 degree C., the product is soft because the product contains large amount fat such as 75% fat. The product becomes hard after cooling. The product is used as a single product or mixed with other feed ingredients such as soybean meal, molasses block or corn meal. When the product is mixed with molasses and processed into a fat-molasses block product, the block product with high fat level is not oily. When the product is mixed with anti-cake agent such as silica or calcium oxide powder, the product has better flowable property. Both products may have the bypass function for dairy animals.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

The oily and pasty sludge (620 grams) from a dissolved air flotation (DAF) unit in an animal processing plant was screened and pressed. Calcium oxide (25 grams) was added into the pressed DAF sludge. After mixing, a water absorbent (8 grams) was added and mixed to form a wet particle product. The wet product was dried in an oven at 105 degree C. for 8 hours. The analytical data were as follows: fat (40.1%), protein (22.3%), and moisture (6.9%). The particle product was non-oily and non-pasty.

### EXAMPLE 2

The oily and pasty sludge (300 grams) from a dissolved air flotation (DAF) unit in an animal processing plant was screened and pressed. Calcium oxide (20 grams) and 50% sodium hydroxide (0.2 grams) were added into the pressed DAF sludge. After mixing, the wet product was dried in an oven at 105 degree C. for 8 hours. The analytical data were as follows: fat (37.5%), protein (23.4%), and moisture (6.5%). The particle product was non-oily and non-pasty.

### EXAMPLE 3

The oily and pasty sludge (500 grams) from a dissolved air flotation (DAF) unit in an animal processing plant was screened and pressed. Calcium peroxide (1 grams) was added into the pressed DAF sludge. After mixing, calcium oxide (30 grams) was added and mixed. The wet product was dried in an oven at 105 degree C. for 8 hours. The analytical data were as follows: fat (39.5%), protein (22.6%), and moisture (8.0%). The particle product was non-oily and non-pasty.

### EXAMPLE 4

The oily and pasty sludge (300 grams) from a dissolved air flotation (DAF) unit in an animal processing plant was screened and pressed. Calcium oxide (20 grams) was added into the pressed DAF sludge. After mixing, Termin-8 (0.2 grams) was added and mixed. The wet product was dried in an oven at 105 degree C. for 8 hours. The analytical data were as follows: fat (38.2%), protein (23.1%), and moisture (7.5%). The particle product was non-oily and non-pasty.

### EXAMPLE 5

The oily sludge (250 grams) of soy soap stock from soybean oil process was heated to 60 degree C. A mixture of calcium oxide (20 grams) and 15% sodium hydroxide (30 ml) was added and mixed for 3 minutes. The liquid product is placed into a large tray and dried in an oven at 105 degree C. for 6 hours and at 180 degree C. for 1 hour. Then the product was cooled at room temperature for overnight and broken into particles. The analytical data were as follows: fat (80.9%) and moisture (3.7%). The particle product was non-oily. The product had the bypass fat (60.6%) by the incubation in rumen fluid for 24 hours and the bypass fat (56.4%) by the incubation in rumen fluid for 48 hours.

What is claimed is:

1. A method of preparing a non-oily and non-pasty sludge product comprising removing moisture from the sludge from a dissolved air flotation unit during waste water treatment in food processing plants, mixing with an alkali and a water absorbent, and heating to convert the oily and pasty sludge into a non-oily and non-pasty product in a particle form.

2. The method of claim 1 wherein the alkali is calcium oxide, sodium hydroxide, magnesium oxide, calcium hydroxide, magnesium hydroxide or in combination.

3. The method of claim 1 wherein the product is by itself or mixed with feed ingredients.

4. The method of claim 1 wherein the product is wet or dry form.

5. A method of preparing a non-oily and non-pasty sludge product comprising removing moisture from the sludge from a dissolved air flotation unit during waste water treatment in food processing plants, mixing with an alkali, and heating to convert the oily and pasty sludge into a non-oily and non-pasty product in a particle form.

6. The method of claim 5 wherein the alkali is calcium oxide, sodium hydroxide, magnesium oxide, calcium hydroxide, magnesium hydroxide or in combination.

7. The method of claim 5 wherein the product is by itself or mixed with feed ingredients.

8. The method of claim 5 wherein the product is wet or dry form.

9. A method of preparing a non-oily product from a vegetable soap stock sludge or its oil in vegetable oil processing plants comprising heating, adding an alkali, drying and cooling to convert the oily sludge or oil into a non-oily product in a solid form.

10. The method of claim 9 wherein the alkali is calcium hydroxide, calcium oxide, sodium hydroxide, magnesium oxide, magnesium hydroxide or in combination.

11. The method of claim 9 wherein a water absorbent is used in the process.

12. The method of claim 9 wherein the product is by itself or mixed with feed ingredients.

13. The method of claim 9 wherein the product is mixed with molasses to be processed into a block product.

14. The method of claim 9 wherein the product is liquid or solid form.
